(19) United States
(12) Patent Application Publication
(10) Pub. No.: US 2003/0002505 A1
(43) Pub. Date: Jan. 2, 2003

(54) Apparatus and method for packet-based switching

(76) Inventors: Thomas A. Hoch, Boxborough, MA (US); John Patrick Jones, Westford, MA (US); Raymond J. Schmidt, Stoughton, MA (US)

Correspondence Address: Troutman, Sanders, Mays & Valentine, Attention: John Curtin, Esq., Suite 600, 1660 International Drive, McLean, VA, 22102, US

(21) Appl. No.: 09/896,723

(22) Filed: Jun. 30, 2001

(51) Int. Cl. H04L 12/28; H04L 12/56

(52) U.S. Cl. 370/392; 370/395.1

(57) ABSTRACT

A packet-based switching device includes a plurality of physical layer interfaces, such as SONET/SDH layer 1 interfaces, and one or more higher-layer processors, such as SONET/SDH layer 2 or 3 processors. One or more digital cross-connects are interposed between the physical layer interfaces and the higher-layer processors. Each digital cross-connect routes communications traffic between the physical layer interfaces and the higher-layer processors. A packet switch core, such as an asynchronous transfer mode (ATM) switch core, routes traffic among higher-layer processors.

### CROSS-REFERENCE TO RELATED APPLICATIONS

This application is related to U.S. patent application Ser. No. 09/711997, entitled Apparatus and Method For Redundancy Of Processing Modules Interfaced To A Switching Core (Chidambaran 1-1-1-1-1-1-1-1), filed Nov. 11, 2000, assigned to the same assignee as this application and which is hereby incorporated by reference.

### BACKGROUND OF THE INVENTION

The present invention relates generally to communication systems and more particularly to packet switching systems having redundancy protection.

### BACKGROUND OF THE INVENTION

Switches used, for example, by communications providers in wide area networks typically provide a number of different interfaces for incoming and outgoing communications traffic to the core switching fabric in order to accommodate customer needs. These interfaces can range, for example, from high rate optical trunking ports to lower rate electrical interfaces. In general, the different interfaces are provided through service specific equipment grouped together on what are termed “service shelves”, where the service shelves then couple to the switching core. A typical service shelf will include the physical layer interface which couples to higher layer service cards (e.g. layer 2 or 3 for ATM or IP) and then to the switching core. Failure protection of equipment utilized in multiservice switches usually in the form of redundant circuit paths is also extremely important in order to provide the type of reliability that is necessary for these switches. Accordingly, extra service cards (or protection cards) are often provided within a service shelf to allow for the required protection. layer interface eliminates the use of the connected higher layer processor. The overall system bandwidth is reduced by a corresponding amount. Accordingly, there is a need to preserve overall system bandwidth in a packet switching system.

### SUMMARY

A switching system in accordance with the principles of the present invention includes a plurality of physical layer interfaces, such as SONET/SDH layer 1 interfaces, and one or more higher-layer processors, such as SONET/SDH layer 2 or 3 processors. One or more digital cross-connects are interposed between the physical layer interfaces and the higher-layer processors. Each digital cross-connect routes communications traffic between the physical layer interfaces and the higher-layer processors. A packet switch core (The term “packet” is used in a generic sense herein and may include packets of various formats, such as ATM cells, for example) routes traffic among higher-layer processors.

In an illustrative embodiment, a plurality of physical layer interfaces in the form of SONET interface cards are coupled through digital cross-connects to a plurality of higher-layer processors, which, in this illustrative embodiment, are located on service cards. Layer 1 SONET operations are performed on the SONET interface cards. Layer 2 or 3 ATM or IP functions are performed on the service cards. The higher-layer processors are linked to the packet switch core, which switches communications traffic among the higher-layer processors. In this illustrative embodiment, a plurality of physical layer interfaces are coupled to three higher-layer processors through two duplex cross-connects. In operation, two of the three higher-layer processors are active and one operates as a higher-layer protection processor which may be switched into the active role upon the failure of one of the two active processors. Similarly, the failure of a physical layer interface may trigger the re-routing of traffic from other sources, such as protection sources, through the cross-connect to a higher-layer processor, thereby preserving the utility of a higher-layer processor in the face of a physical layer interface's failure.

Automatic protection switching (APS) may be effected at the physical layer, for example, by providing 1:1, 1+1, or 1:N protection through the digital cross-connect. The physical interfaces may also support bidirectional line-switched or unidirectional path-switched rings (BLSR or UPSR, respectively).

### BRIEF DESCRIPTION OF THE DRAWINGS

The above and further features, aspects, and advantages of the invention will be apparent to those skilled in the art from the following detailed description, taken together with the accompanying drawings in which:

FIG. 1 is a conceptual block diagram of a physical layer/higher layer processor in accordance with the principles of the present invention;

FIG. 2 is a more detailed conceptual block diagram of the processor of FIG. 1;

FIG. 3 is a more detailed conceptual block diagram of the processor of FIG. 2;

FIG. 4 is a conceptual block diagram of a packet-switching system which employs a physical layer/higher layer processor in accordance with the principles of the present invention;

FIG. 5 is a detailed block diagram of a service shelf component of the packet switching system of FIG. 4;

FIG. 6 is a detailed block diagram of a core interface card component of the packet switching system of FIG. 4;

FIG. 7 is a detailed block diagram of an aggregator as used in connection with the present invention;

FIG. 8 is an exemplary embodiment of a core interface card for a low speed shelf;

FIG. 9 is an exemplary embodiment of a higher level service card as used in connection with the present invention; and

FIG. 10 is an exemplary block diagram of an arbiter function as used in connection with the present invention.

### DETAILED DESCRIPTION

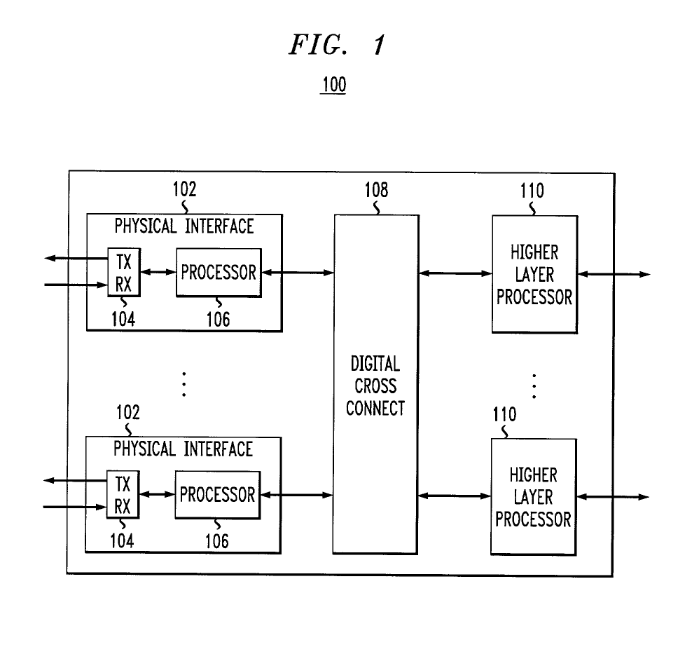

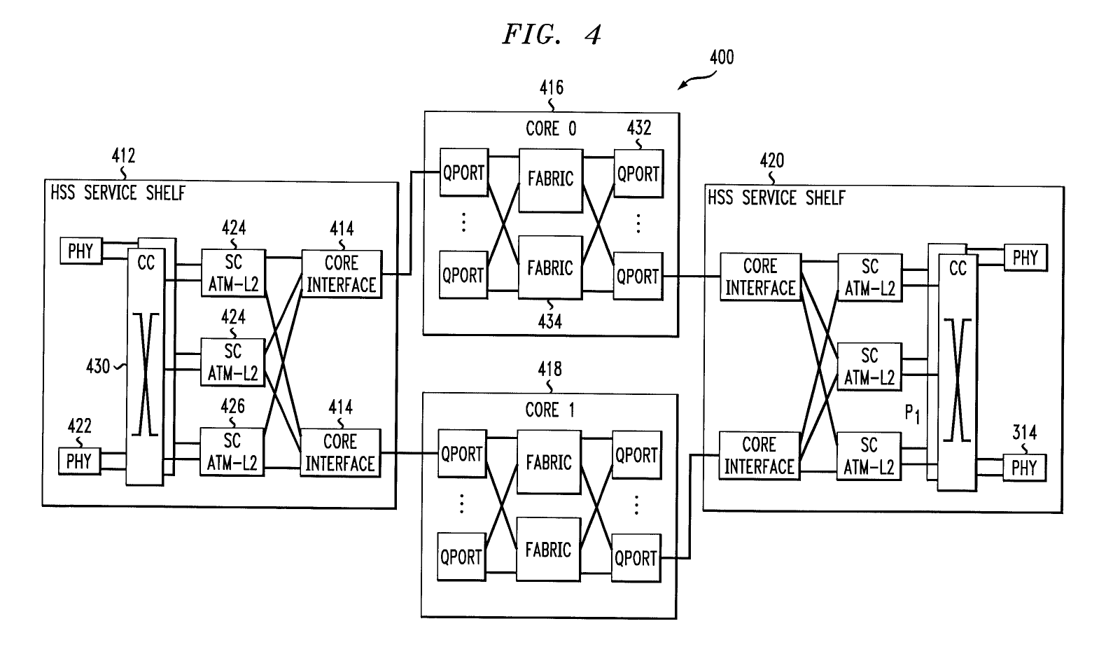

The conceptual block diagram of FIG. 1 illustrates a physical layer/higher-layer processor 100 in accordance with the principles of the present invention. As will be described in greater detail in the discussion related to FIGS. 4 through 10, the physical layer/higher-layer processor may be combined with other components to form a packet-based switching system. The physical layer/higher-layer processor 100 includes a plurality of physical layer interfaces 102. Each of the physical layer interfaces 102 provide physical layer functions, such as SONETISDH layer 1 functionality, and may include, in addition to optical and/or electronic receivers and transmitters 104, transport processing components 106, such as SONET of SDH transport processing components.

The receivers and transmitters 104 associated with each physical layer interface 102 accept telecommunications signals from, and transmit telecommunications to, a telecommunications system which accesses the services of a packet switch (not shown in this figure) through the physical layer/higher layer processor 100. The physical layer interfaces 102 are connected through a digital cross-connect 108 to a plurality of higher layer processors 110. The higher layer processors 110 provide higher layer services, such as IP/ATM layer 2 or layer 3 services. Communications traffic travels between the physical layer interfaces 102 and the higher layer processors 110 through the digital cross-connect 108 on its way to and from the packet switch to which the higher layer processors 110 are coupled. In one aspect of the present invention, protection switching, such as 1+1, 1:N, or 1=1, protection switching, is performed at the physical layer interfaces 102. Consequently, if one of the physical layer interfaces 102 fails, a protection path through another of the physical layer interfaces will carry the protection traffic, which may be routed through the digital cross-connect 108 to whichever of the higher layer processors 110 had been handling the working traffic from the failed physical layer interface. In this manner, unlike conventional packet switching systems, a higher layer processor will still find use, even if a physical layer interface from which the higher layer processor is receiving or to which it is transmitting communications traffic, fails.

Automatic protection switching (APS) may be effected at the physical layer, for example, by providing 1:1 or 1:N protection through the digital cross-connect. The physical interfaces may also support bidirectional line-switched or unidirectional path-switched rings (BLSR or UPSR, respectively). Automatic protection switching is known and discussed, for example in Bellcore GR-253, which is hereby incorporated by reference. A switchover triggering event may be detected in the K1/K2 overhead. For example, the digital cross-connect may be configured to broadcast telecommunications received from a physical layer interface, thereby forming a permanent bridge and allowing the cross-connect to switchover from one physical layer interface to another in a 1:1 protection scheme.

The digital cross-connect 108 may be implemented, for example, as a SONET digital cross-connect system, which provides broadband support in terms of traffic grooming, traffic consolidation, test access, broadcast, add/drop, facility rolling and protection. “Traffic grooming” refers to the process of accepting traffic from one source, breaking it down into components and sending it to a different egress port. “Traffic Consolidation” refers to the process of combining multiple low-rate inputs into one high-rate output. “Test Access” support is offered in the form of a dedicated “test” port that is capable of monitoring traffic flows and/or injecting “test” traffic into the cross-connect. “Protection” support refers to the cross-connects' facility for monitoring and switching traffic from a failed port to a backup port. In particular, if a SONET broadband digital cross-connect systems is employed for the cross-connect 108, the cross-connect 108 would be capable of cross-connecting at the STS-1 (or DS3) and higher levels with SONET multiplexing and termination. A packet-based switching system in accordance with the principles of the present invention which employs a SONET BDCS as the cross-connect 108 may readily support network unbundling, SONET rings, and network hubbing, for example, by providing a protection mechanism for interconnecting equipment.

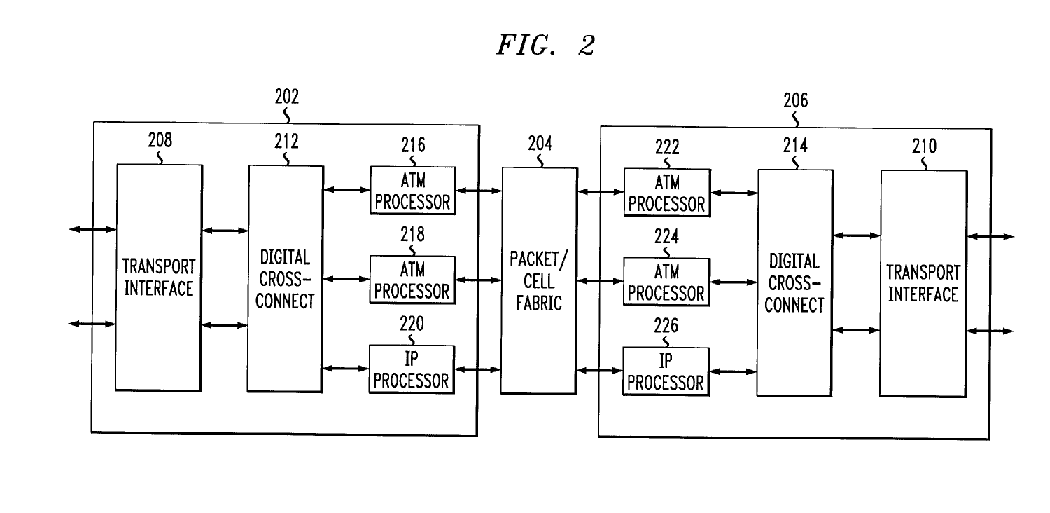

The conceptual block diagram of FIG. 2 illustrates a packet switching system which employs a physical layer/higher-layer processor in accordance with the principles of the present invention, as described in the discussion related to FIG. 1. For the sake of clarity and ease of description, this illustrative embodiment includes two physical layer/higher layer processors, one 202 with physical layer interfaces connected to the broader network (not shown) to the “west”, that is, to the left of FIG. 2, and connected to a digital packet/cell switch fabric 204 to the “east”, that is to the right of FIG. 2. The packet switch fabric 204, an asynchronous transfer mode (ATM) switch fabric in this illustrative embodiment, routes traffic among higher-layer processors. The second physical layer/higher-layer processor 206 is connected to its west to the digital packet/cell switch fabric 204 and to its east to the broader network (not shown) through physical layer interfaces to its east.

The physical layer/higher layer processors of this illustrative embodiment are depicted from a slightly different perspective than that of FIG. 1. For example, the transport interfaces 208 and 210 each include a plurality of physical layer interfaces, such as physical layer interfaces 102 of FIG. 1 and the digital cross-connects 212 and 214 may be implemented as the digital cross-connect 108 of FIG. 1. Additionally, the plurality of higher layer processors 216, 218, 220 within the physical layer/higher layer processor 202 and the plurality of higher layer processors 222, 224, 226 within the physical layer/higher layer processor 206 may be implemented as the higher layer processors 110 of FIG. 1, however, as illustrated, higher layer processors 216, 218, 222, and 224 are asynchronous transfer mode (ATM) processors that provide ATM processing services and higher layer processors 220 and 226 are frame relay/Internet protocol (FR/IP) processors that provide frame relay Internet protocol processing services.

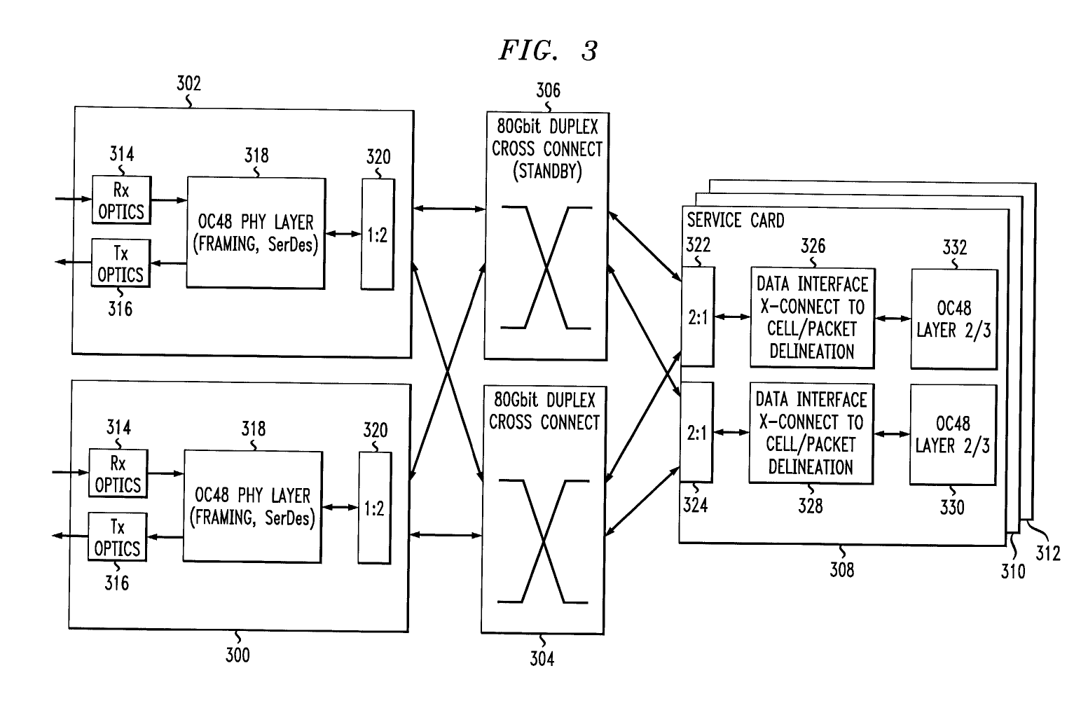

The conceptual block diagram of FIG. 3 provides another, more detailed, illustration of a specific embodiment of a physical layer/higher layer processor in accordance with the principles of the present invention. In this illustrative embodiment, a plurality of physical layer interfaces in the form of SONET interface cards 300 and 302 are coupled through digital cross-connects 304 and 306 to a plurality of higher-layer processors, which, in this illustrative embodiment, are located on service cards 308, 310, and 312. Layer 1 SONET operations are performed on the SONET interface cards 300 and 302. Layer 2 or 3 ATM or IP functions are performed on the service cards 308, 310, and 312. The higher-layer processors are linked to the packet switch core (not shown in this view), which switches communications traffic among the higher-layer processors. In this illustrative embodiment, two physical layer interfaces 300 and 302 are coupled to three higher-layer processors 308, 310, and 312 through two duplex cross-connects 304 and 306.

In operation, two of the three higher-layer processors, e.g., 308 and 310, are active and one, e.g., 312, operates as a higher-layer protection processor which may be switched into the active role upon the failure of one of the two active processors 308 and 312. Similarly, the failure of a physical layer interface may trigger the re-routing of traffic from other sources, such as protection sources, through the cross-connects 304 and 306 to a higher-layer processor (one of processors 308, 310, or 312), thereby preserving the utility of a higher-layer processor in the face of a physical layer interface's failure. Additionally, in this illustrative embodiment, one of the cross-connects 306 operates as a standby cross-connect and the other cross connect 304 operates as a working cross-connect, thereby providing a further layer of redundancy and fault protection. That is, should the working cross-connect 304 fail, the standby cross-connect 306 will assume its duties.

Each of the SONET interface cards 300 and 302 includes receive 314 and transmit 316 optics which communicate with a physical layer processor 318. In this illustrative embodiment, the physical layer processor 318 performs OC48 physical layer operations, including framing and serialization/de-serialization. Each of the SONET interface cards 300 and 302 also includes a multiplexer/demultiplexer 320 which provides an interface between the physical layer processor 318 and each of the redundant duplex cross-connects 304 and 306. Communications traffic may travel to/from either of the illustrated SONET interface cards 300 or 302 through either of the cross-connects 304 or 306 to/from any of the service cards 308, 310, or 312.

Each of the service cards 308, 310, 312 includes multiplexer/demultiplexers 322 and 324 which provide an interface between the cross-connects 304 and 306 and data interfaces 326 and 328. The data interfaces 326 and 328 operate to delineate cells and packets in the data streams received from the digital cross-connects 304 and 306, or, alternatively, to assemble or encapsulate packets and cells received from OC48 layer 2/3 processors 330 and 332 into data streams suitable for transmission through the SONET cross-connects 304 and 306. They also combine streams from cross-connects 304 and 306 and from various interfaces and presents them to the layer 2/3 functionality.

A packet-based switch in accordance with the principles of the present invention may be used as a multiservice switch. Such switches, when used by communications providers for wide area networks, for example, typically provide a number of different interfaces for access to and from the core switching fabric in order to accommodate customer needs. The different interfaces may be provided through service shelves which then couple to the switching core.

Such a switch may include a core interface mechanism that permits 1:N type port protection on the core side of the switch such that core bandwidth is not wasted by the direct connection of service cards to the switching core. Referring to FIG. 4, there is shown one exemplary embodiment of a multiservice switch 400. The switch 400 includes a service shelf 412 which incorporates a core interface 414. As would be understood, the functional blocks illustrated in the figure may take the form of one or more cards or modules that are insertable into a rack or other similar type system. The service shelf 412 couples to first and second redundant switching cores 416, 418. A second service shelf 420 couples to what can be considered the output side of the switching cores.

As shown, the general makeup of the service shelf 412 includes a physical layer interface card 422 which is a user interface that can be an optical or electrical interface, e.g., DS3, OC-12, OC-48, OC-192, etc. In the case of the high speed shelf shown, the physical layer is generally a high density optical interface such as OC-48 or OC-192. The physical layer card 422 couples to higher level service cards 424, 426, 428 (for example, layer 2 or layer 3 for ATM or IP) through a cross connect device 430, for example, a SONET STS-1 level cross-connect. The service cards 424 couple to the switching core through core interface modules 414. As shown, the switching cores 416, 418 are traditional switch cores including input/output ports 432 as well as switching fabrics 434. The physical layer interface card 422, cross-connect device 430, and higher level service cards 424 and 426 combine to form a physical layer/higher processor, as described in the discussion related to FIGS. 1,2, and 3. Multiple sets of higher level service cards may be connected to the cross-connect device 430.

The interface mechanism between the service cards 412 and the core 416, 418 provides redundancy protection between the service cards and core without the requirement that extra core bandwidth be allofted for the protection cards. As shown in the exemplary embodiment, two on-line ATM service cards 424 are protected by one back-up or protect service card 426. The core interface card 414 permits routing of core data to and from any of the three cards. In addition, the protection card 426 can be switched in place without the corresponding re-routing having to be known to the rest of the system.

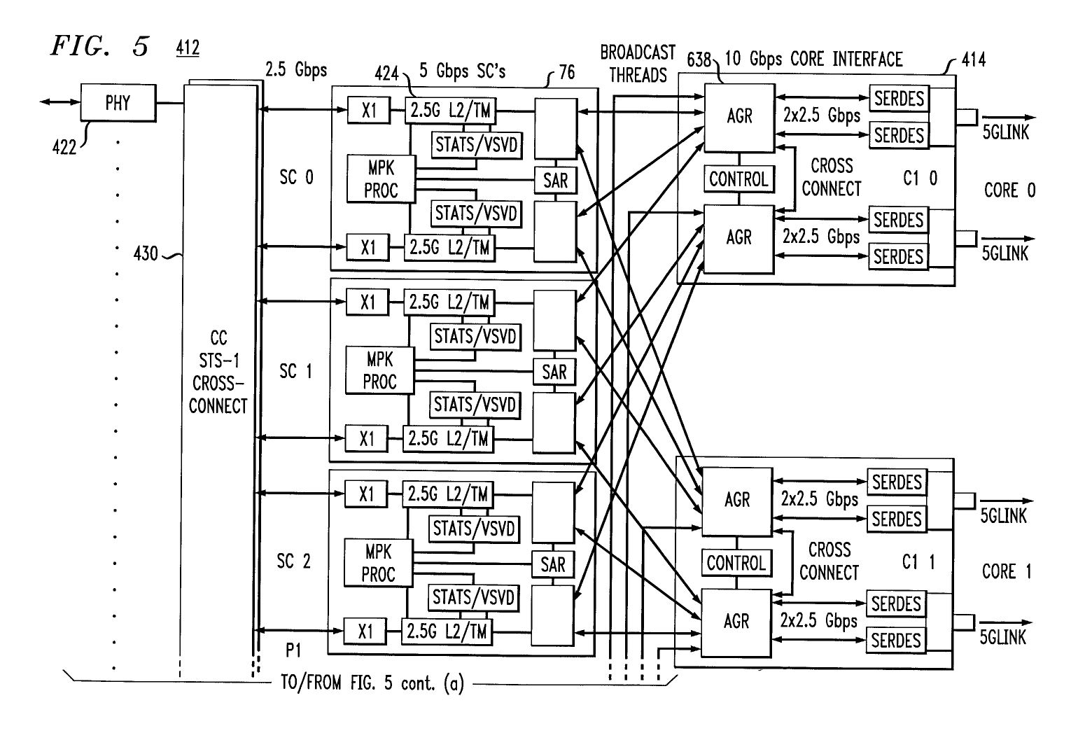

Referring to FIG. 5, a detailed block diagram of a service shelf 412 in accordance with the present invention is shown. FIG. 5 illustrates the interface between the service cards 424, 426 and the switching core via the core interface modules 414, where the specific interconnects between the service cards and the core interface are shown. In the exemplary embodiment, the service shelf 412 includes nine service cards (SC0-SC8) which couple, respectively, to six core interface cards (C10-C15). As in FIG. 4, two on-line service cards 424 and one protect service card 426 couple to the switching cores through each core interface card providing 1:2 redundancy. Also included in the service shelf are shelf control processor cards 536 which handle administrative processing functions for the shelf.

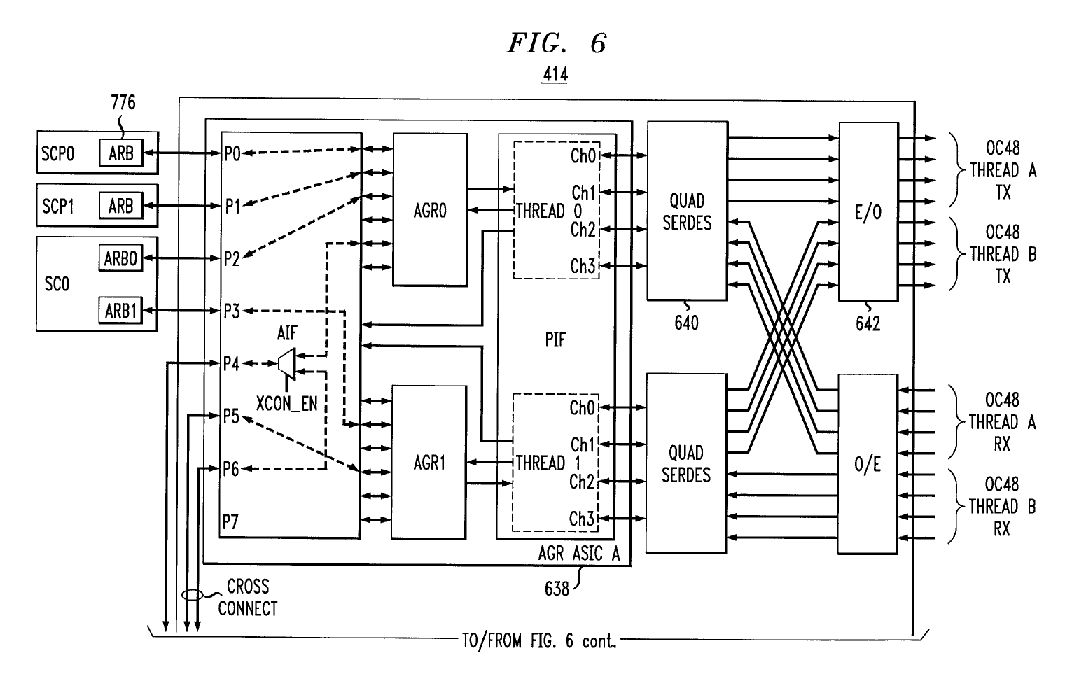

The core interface cards 414 couple to redundant switch cores 416, 418 (illustrated in FIG. 4). A core interface card 414 monitors its link to the core and reports status to the shelf control processor 536 on the service shelf. Referring to FIG. 6 in combination with FIG. 5, an exemplary block diagram of a core interface card 414 is shown. As shown, service cards 424, 426 couple to the core through an aggregator device 638 in the core interface card 414. Interconnections between the aggregator in the core interface and the arbiter blocks on the service cards are illustrated with double arrows. (FIG. 5). The aggregator device 638 acts as an interface between the service cards 412 and the switching core and essentially distributes core traffic throughout the service shelf. The aggregator 638 acts a datapath flow switch, directing flows to either the normally active service card slot or to the dedicated protection slot. In all cases, the aggregator 638 will allow control information connectivity through the core to all attached service cards 424, 426 and shelf control processors 536. Although shown and described as an applications specific integrated circuit (ASIC), it would be understood that the functionality of the aggregator 638 as described herein may also be implemented using discrete components, programmable device or a combination thereof. As shown in FIGS. 5 and 6, the core side of the aggregator 638 couples to multiple serializer/deserializer blocks 640. The implementation and function of a serializer/deserializer would be well known to a person skilled in the art. The serializer/deserializers 640 couple to optical/electrical (O/E) components 642 in order to provide the interface to the switching core. Failure of a link will be detected by a serializer/deserializer 640 or the aggregator device 638 and reported to the shelf control processor 536 through a control interface on the aggregator. Failures may be detected, for example, by the loss of a clock signal corresponding to the link or an invalid parity across the link. Other types of failures that are detectable and that can be characterized as a link failure would be apparent to those skilled in the art. As will be explained, the shelf control processor 536 (in combination with the aggregator 638) trigger appropriate corrective action in response to a link failure. The aggregator 638 on the core interface card 414 also contains a thread switch function 644 for service card protection. The switch function 644 allows the core interface card 414 to steer traffic on a given thread to/from an active service card to a protection card. For the shelf, service card protection will be 1:2. The core interface card 414 (and the shelf control processor 536) will control the protection switching of the interface. In addition, as will be explained, an arbiter function on the service card can detect link failures on the basis, for example, of the receipt/non-receipt of link test cells.

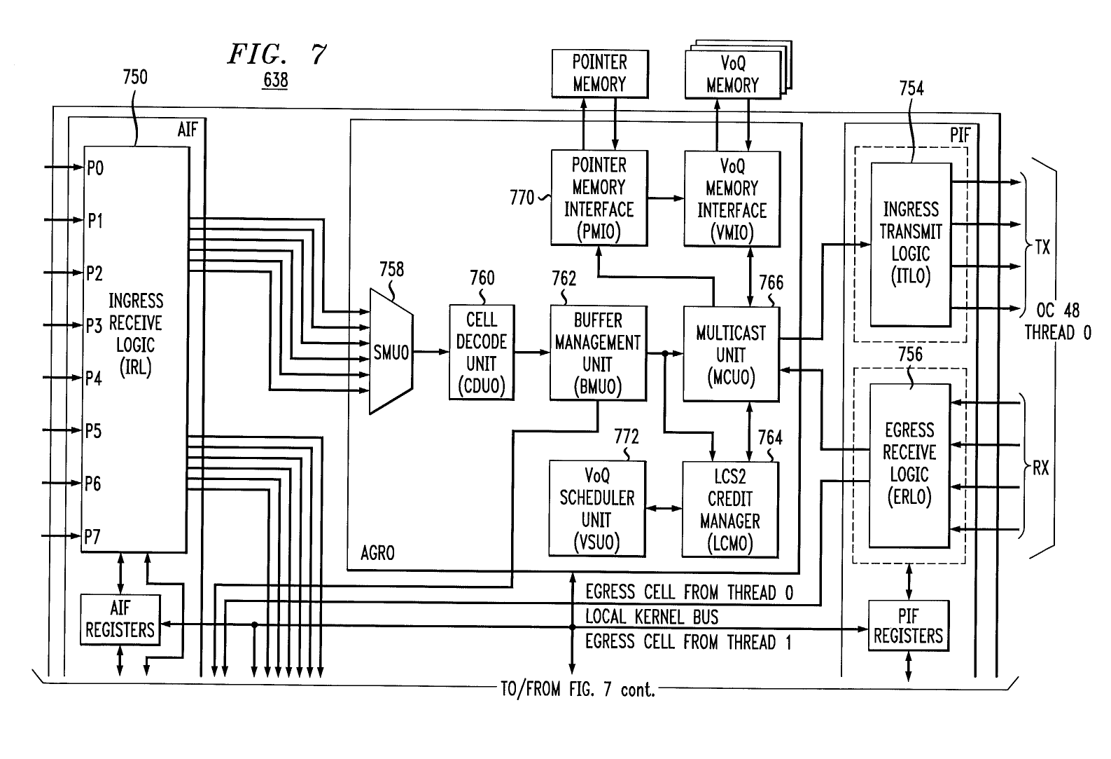

FIG. 7 shows a functional block diagram of the aggregator device 638. The aggregator 638 includes ingress receive logic 750 and egress transmit logic 752 on the service card side. Ingress transmit logic 754 and egress receive logic 756 are also found on the core side of the aggregator 638. There are two aggregation functions—AGR0 and AGR1—implemented in the aggregator (AGR) ASIC, each performing an aggregation of up to 6 independent data streams into a 2.5 Gbps thread. These two aggregation functions are independent and the operation of one does not affect any state of the other. In one exemplary embodiment, each aggregator function AGR0, AGR1 includes a multiplexer unit 758 which couples to the ingress receive logic 750, a cell decode unit 760 which couples to the output of the multiplexer 758 and a buffer management unit 762 which couples to the output of the cell decode unit 760. A credit/grant manager function 764 and a multicast unit 766 each couple to the output of the buffer management unit 762. A virtual output queue (VOQ) memory interface 768 and a pointer memory interface 770 each couple to the multicast unit 766. A VOQ scheduler 772 couples to the credit/grant manager 764.

The AGR ASIC communicates with the service shelf cards through an arbiter (ARB) ASIC 776 over an 8-bit LVDS (low voltage differential signal) interface (FIG. 5). This interface runs, for example, at 266 MHz with data being transferred on both clock edges. As shown, the AGR ASIC has 8 ARB interface (AIF) ports. Four of these AIF ports can be configured to connect to either of the aggregation functions in the AGR ASIC. Of the remaining four AIF ports (P0-P7), two are connected to aggregation function 0 (AGR0) and the other two are connected to aggregation function 1 (AGR1). Thus, a maximum of six AIF ports can be connected to each aggregation function. In the ingress direction, each aggregation function statistically multiplexes a combination (maximum of 6 data streams) of OC-12, 2×OC-12, and OC-48c data streams into a 2.5 Gbps stream. In the egress direction, each aggregation function broadcasts an OC48 thread coming from the core to the six (6) ARB ASICS connected to that thread.

As discussed above, the AGR ASIC communicates with the switch core, for example, on OC-48 links through quad serializer/deserializer (Serdes) 40 and Optical/Electrical ports 642. The Serdes transmitter 640 serializes and encodes the data, e.g. 8B10B data, for proper transmission over the fiber link. The receiver will deserialize, decode and also synchronize the four channels (channel lock) before transmitting the data to the aggregator (AGR) ASIC 638. Optical/Electrical components take the electrical signals produced by the Serdes and convert them to optical signals for fiber link transmission and take optical signals from the link and convert them to electrical signals for Serdes processing. In one embodiment of the invention, for example, a 96-byte data cell is striped among four channels. This data cell includes the 84-byte packet and 12-bytes of control data. Data is transferred between the aggregator ASIC and each Serdes on a 4×8-bit unidirectional bus. This cell is transmitted in twenty-four 155.52 MHz-clock cycles.

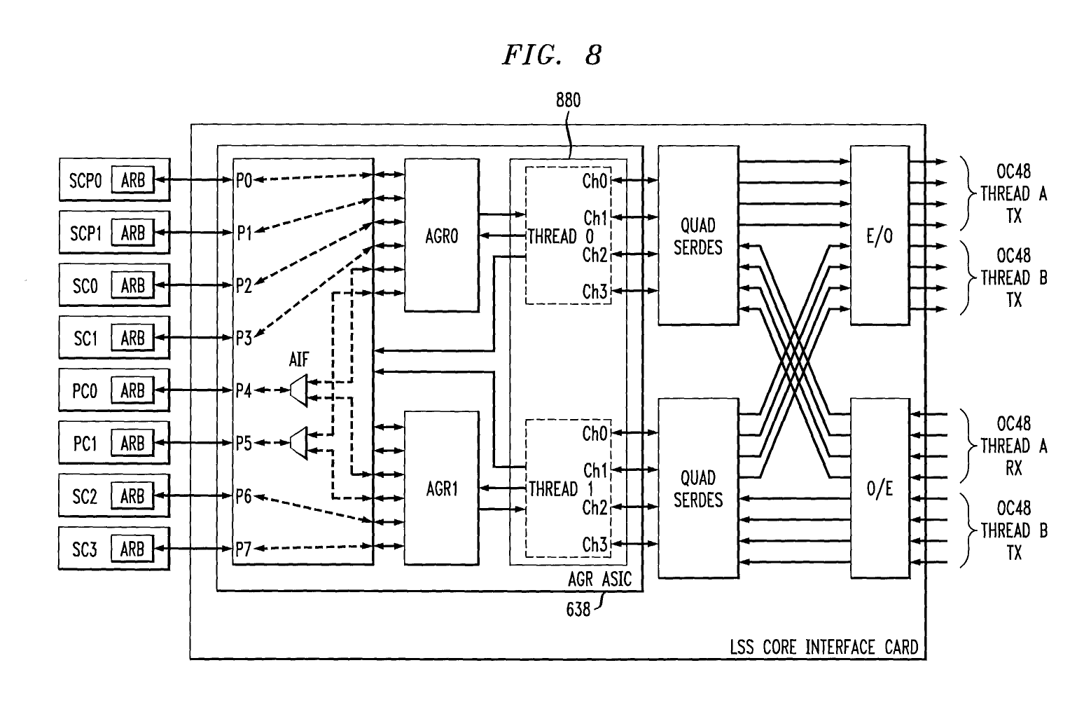

The AGR ASIC 638 is used in high speed and low speed applications, where the respective service shelves are accordingly termed high speed service shelves (HSS) and low speed service shelves (LSS). In the HSS and LSS applications, the AGR 638 resides in the HSS and LSS core interface cards, respectively. In the exemplary embodiment of the high speed shelf 412, the core interface card in the HSS uses two AGR ASICS 638 and provides 10 Gbps (4×2.5 Gbps) interface to the switch core. In the exemplary embodiment of the low speed shelf (see FIG. 8), the core interface card 880 in the LSS uses one AGR ASIC 638 and provides 5 Gbps (2×2.5 Gbps) interface to the Switch Core. The AGR is software configurable based on the specific application.

In the exemplary embodiment, the AGR ASIC includes 8 AGR-ARB interfaces each with a data rate of OC48. All of the eight AGR-ARB interfaces (AIF ports P0 through P7) are software configurable to operate the AGR ASIC in different configurations required for different shelves (e.g. the High-Speed Shelf and Low-Speed Shelf. Setting a corresponding port enable bit in AIF Port Control Register 0 & 1 can activate each interface. AIF ports P0 & P1 are connected to the aggregation function 0 (AGR0) and ports P6 & P7 are connected to aggregation function 1 (AGR1). Ports P2 through P5 can be connected to either aggregation functions (AGR0 or AGR1), depending upon the AGRn_SEL bit in the AIF Port Configuration Register. Therefore, at any time at most 6 AIF ports can connect to one OC-48 thread.

In the high-speed shelf, the core interface card 414 has two AGR ASICs 638 (AGR-A and AGR-B) residing on it and provides an aggregate bandwidth of 10 Gbps to the core. Each AGR ASIC 638 is connected to one 5 Gbps high-speed service card and to one of the two 2.5 G ARB interfaces on the protection card. One of the two AGR ASICs will also have a shelf control processor (SCP) card(s) connected to it. Each SCP has an average data rate of 622 Mbps (OC-12).

In the low-speed shelf (FIG. 8), the core interface card 880 has one AGR ASIC 638 and provides two 2.5 Gbps aggregated threads to the core. The AGR ASIC interfaces with the ARB ASIC in 4 low-speed service cards, 2 protection cards, and 2 shelf control processor (SCP) cards. All low-speed cards have an average data rate of 2×OC-12, however, in burst traffic conditions, the interfaces can support a peak data rate of OC-48. FIG. 8 shows AGR in LSS core interface card.

Referring again to FIGS. 4 and 5, it can be seen that the service cards 424, 426 will receive flows from the redundant cores through the core interface card 414. An arbiter function (ARB) 776 in the service cards 424, 426 will monitor the end to end path of the flows through special in-band test messages over both cores. If a flow is failed, the destination ARB will automatically switch and accept traffic through the protection path from the redundant core and core interface card (this needn't affect other flows within the switch). The source ARB will always broadcast traffic and test messages through both cores. The AGR interfaces with an Arbiter device/circuit that resides on all service cards and shelf control processors 36 to complete the core interface. From a high level the ARB 776 is intended to merge traffic flows from each core as necessary, on a per flow basis, and act as a header translator and filter for traffic flows from the cores. The ARB and AGR also provide flow checking and fault detection checking. A significant advantage of the present invention is the ability to switch individual flows without impacting other flows within the switching system.

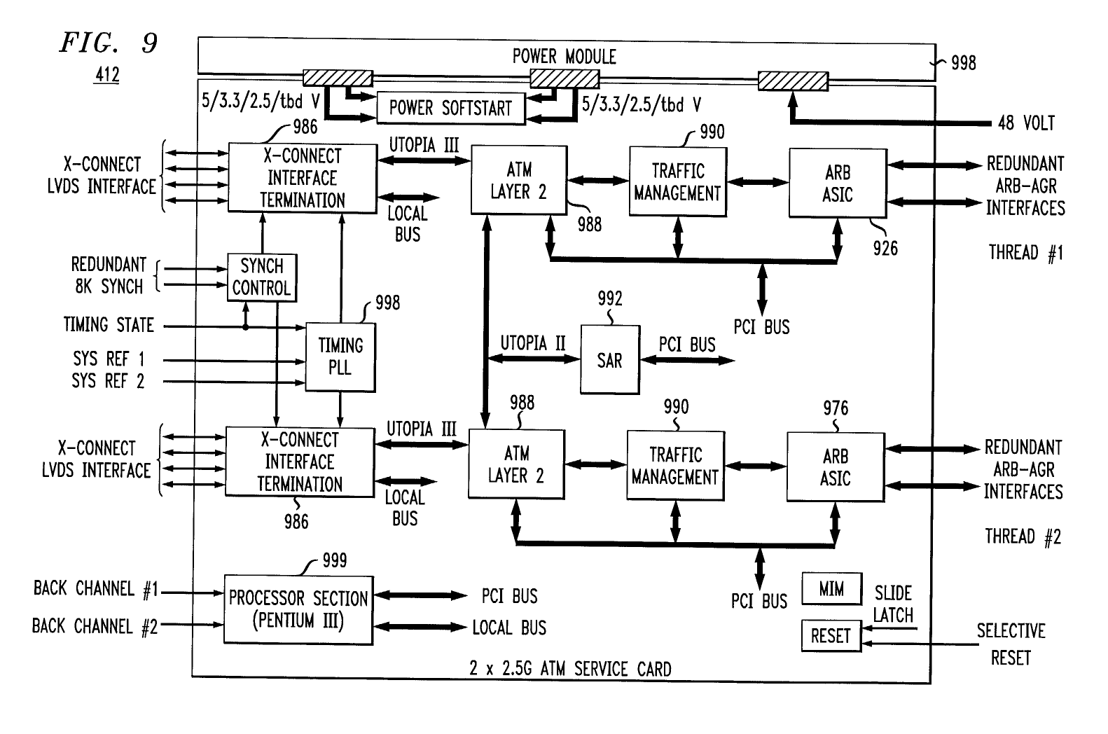

Referring to FIG. 9, one exemplary embodiment of a high level service card 412 is shown. As illustrated, the service card is an ATM service card, although it would be understood that other types of service cards, for example IP, frame relay, and TDM. The service card shown provides 2×2.5 Gbps threads and provides the ATM layer and traffic management functions for the service shelf. As shown, cross connect interface terminations 986 couple to the ATM (layer 2) processing blocks 988. The ATM blocks 988 couple to respective traffic management functional blocks 90 as well as to the ARB ASIC 976 providing the two threads. The ATM layer blocks 988 also couple to a segmentation and reassembly function (SAR) 992 that couples to a local processor 994 via a PCI bus. The service card also includes timing and power functions 998.

The Arbiter ASIC, or ARB ASIC 976, will be used in the switching system as a flow control mechanism for cell traffic as well as a test cell generator and receiver for system level flow verification. As with the aggregator device, although the exemplary embodiment is described with respect to an ASIC, it would be understood that such a device may also be implemented using discrete components. The ARB is utilized, for example, in the high speed shelf, the low speed shelf, and interfaces on one side to a physical layer device such as a scheduler, also known as a traffic manager or TM. On the opposite side, the ARB interfaces to the aggregator (AGR). The ARB ASIC includes a UTOPIA II bus for interfacing with a SAR for processor to processor communication. The ARB also supports an external memory interface for GMID (global multicast ID) to ECID (egress circuit ID) translation. The ARB ASIC contains a test cell generator and a test cell receiver to test online and off-line cell flows through the core.

The ARB resides on a service card and forwards user traffic (from the physical interface) to the core interface cards at an OC48 (2.5 Gbps) rate. The ARB receives traffic from the core interfaces and will forward traffic destined to its TM device. An ARB also resides on the SCP. In the SCP application, the ARB interfaces to a SAR device to enable processor to processor communication and will not interface to a TM device.

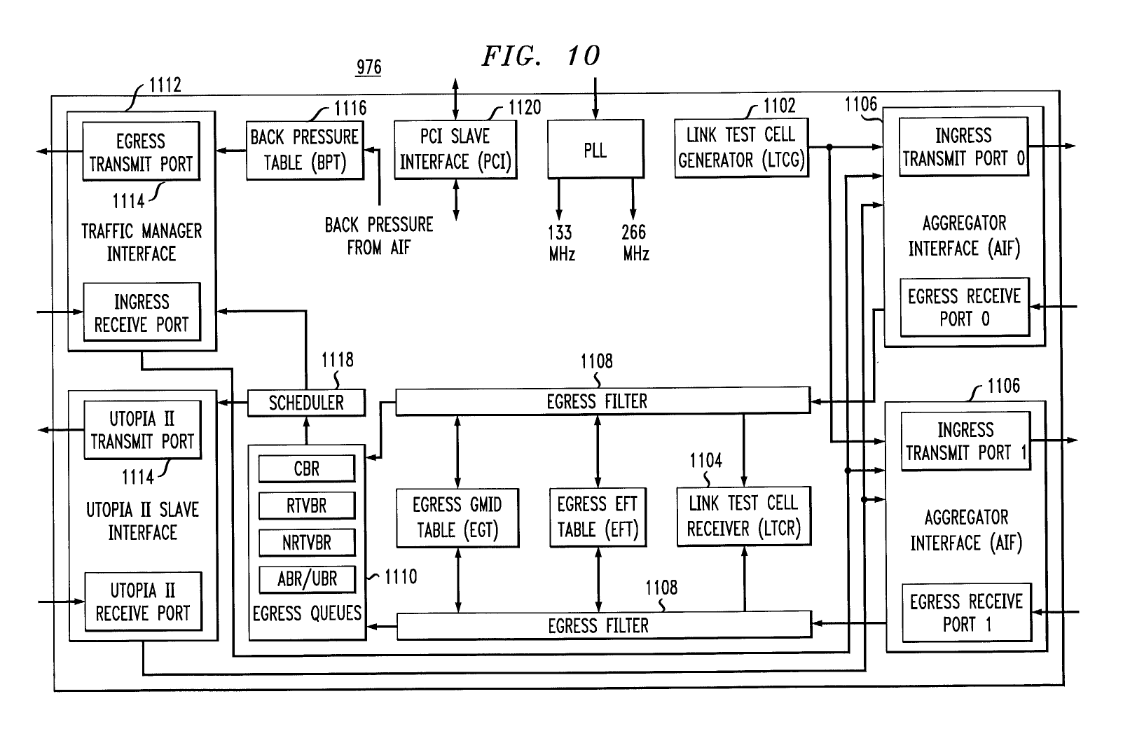

Referring to FIG. 10, a functional block diagram of the ARB ASIC 976 is shown. The exemplary embodiment of the ARB includes six interfaces: a PCI (processor interface) interface, a physical layer interface (PI Sched RX and TX), a SAR interface (RX and TX), two AGR interfaces (RX and TX, one per core) and an external memory interface. As discussed previously, the ARB includes a link test cell generator 1102 and a link test cell receiver 1104 which will be used in the system to verify flow integrity. The link test cell (LTC) generator 1102 and receiver 1104 couple to the aggregator interface 13 106, the link test cell receiver 1104 coupling through respective egress filters 1108. The ARB also includes internal priority queues (four QOS levels) 1110 for egress traffic, the inputs of which couple to the egress filter 1108. The priority queues couple to egress transmit ports (TM and Utopia) 1112, 1114 through a scheduler 1116 or 1118. The egress filters 1108 in the ARB provide a filtering function that is used to determine if the ARB should accept unicast and multicast cells from the AGRs.

The ARB 976 operates in one of two modes. If the ARB resides on a service card (either in the high speed shelf or the low speed shelf), the ARB will be in TM mode in which all traffic is sent and received via the TM device or via the test cell interface. If the ARB resides on a processor card the ARB will be in SAR mode in which all traffic will be sent and received via the SAR or via the test cell interface.

From an ingress standpoint (with relation to the core), if the ARB 976 is in TM mode, user cells will enter through the physical layer interface TM. BIP8 calculations (bit interleaved parity across 8 bit boundaries) will be checked on a per cell basis and optionally drop BIP8 erred cells. Cells entering the ARB through the physical layer interface will be broadcast to both AGR ports (and sent to both cores). Internally generated link test cells will be combined with the user traffic in the ARB ASIC and sent to both AGR ports. The link test cell generator 1102 can optionally back pressure the TM device using a back pressure table 1116 to create space for test cell insertion. If no user cells or test cells exist, idle cells will be inserted to sustain the flow.

If the ARB is in SAR mode, cells will be accepted from the SAR device and the TM interface will be ignored. Again, the SAR cells will be combined with the internally generated test cells and sent to both AGR ports.

From an egress standpoint, cells will enter the ARB via one of two AGR interfaces. When a cell first enters the ARB, a check will be done to determine if the cell is a test cell, a unicast cell, a multicast cell, or an idle cell. Filters and checks will be done to forward the cell to the appropriate interface (TM/SAR or LTC receiver). BIP8 calculations will be checked on a per cell basis and optionally drop BIP8 erred cells. Cells destined for the TM/SAR are placed in one of four priority queues 1110 based on a QOS field in the cell. Cells from both AGR interfaces are placed into the same queues. Cells will be read from the priority queues based on either a fixed priority or a programmable priority depending on scheduler mode and sent to the TM or SAR based on mode.

The egress queue back pressure mechanism will exist to prevent the egress priority queues from overflowing. Back pressure information will be inserted into the ingress path back to the AGRs. The ARB will also track and forward back pressure information from the AGRs to the TM device.

The PCI interface 1120 provides access to on chip register and tables as well as off chip memory. In an exemplary embodiment, the PCI interface will be 32 bits wide and support a maximum frequency of 33 MHz. Burst access will be provided to on chip tables and off chip memory when the corresponding function is not enabled.

In accordance with the present invention, it can be seen that at the service shelf (SS) level the core interface cards are redundant on a per core basis. The service cards (SC) are 1:N redundant, (e.g., 1:2) without wasting core bandwidth. The AGR provides support for 1:N service card redundancy in the HSS and LSS applications. FIG. 6 and FIG. 8 depicted the AGR in the high-speed and the low-speed configurations. In the HSS application (see FIG. 6), the core interface card 414 connects to one protection card (PC) that can protect any one of two service cards (SC0 and SC1). In the LSS application (see FIG. 8), the core interface card 80 connects to two protection cards (PC0 and PC1) each can protect any of the four service cards (SC0, SC1, SC2, and SC3).

In the HSS application, as shown in FIG. 6, ARB0 and ARB1 of the SC0 and ARB0 of the PC are connected to AGR ASIC-A. Similarly, ARB0 and ARB1 of the SC1 and ARB1 of the PC are connected to AGR ASIC-B. Since there are two service cards (SC0 and SC1) each connected to two different AGR ASICs and there is only one protection card (PC) to protect them, a cross-connect is needed between two AGR ASICs on the HSS CIC card. When PC is protecting the SC0, PC-ARB0 protects SC0-ARB0 directly and PC-ARB1 protects SC0-ARB1 indirectly through the external cross-connect. Conversely, when PC is protecting the SC1, PC-ARB1 protects SC1-ARB1 directly and PC-ARB0 protects SC1-ARB0 indirectly through the external cross-connect. The cross-connect enable bit (XCON_EN) in the AIF Redundancy Register is provided to enable and disable the external cross-connect. When enabled, the protection port on the AGR ASIC protects the “remote” ARB connected through the external cross-connect. When XCON_EN is disabled, the protection port on the AGR would protect the “local” ARB. For example, if the XCON_EN bit in AGR ASIC A is enabled, PC-ARB0 would protect SC1-ARB0 through the external cross-connect. If the XCON-EN bit in AGR ASIC A is disabled, PC-ARB0 would protect SC0-ARB0. This XCON-EN bit is used in HSS applications only and it should be disabled in LSS and NEP applications.

In the LSS application (see FIG. 8), since there is only one AGR ASIC on the core interface card, external cross-connect is not needed. Therefore, the XCON_EN bit is disabled and only AGRn_SEL bits for the protection ports are used to configure the protection ports. On the ingress side, data from a protection card can go to one of two OC-48 threads to the switch based on the card it is protecting. Similarly, on the egress side, data from one of two threads can now go to a protection card. The AGRn_SEL bit (in AGRn Port Configuration Register associated with the protection port is used to select one of two threads. This bit is set by the processor during switchover.

As discussed, support for 1:N service card redundancy is provided in the AGR 638. In the described embodiments of the HSS and the LSS one protection card (a hot standby) is provided for every two service cards. In order to provide the redundancy protection and allow for seamless traffic switchover between the protection card and service card, an address mapping scheme, termed a Z-mapping scheme (after the different address fields) is implemented.

All the ARB ASICS 976 in a switch utilizing the present invention interface are uniquely identified from a flow/connection standpoint based on an X.Y.Z addressing scheme. The X portion of the address represents an 8-bit OC192 port ID used for addressing one of 256 fabric output ports. A 2-bit Y field addresses the four OC 48 ports within an OC 192 port addressed by X. That is, Y specifies one of the four OC48 links between the switching core and a core interface card. A 3-bit bit Z field addresses an ARB ASIC or AIF port associated with an OC48 thread (PIF thread). The X.Y.Z value is stored in the packet header and is used by the switch fabric in the core and the line card on the service shelf to route packets to the correct destination card/port.

On the egress side, all user data cells and test cells received from the core are broadcast to all ARBS associated with an OC48 PIF thread. These cells contain a 3-bit E_Z (egress) field that identifies one of 8 destination ARBs connected to the AGR. Each ARB also has a unique Z ID stored in its Z[2:0] register. Upon receiving a cell from the AGR, the ARB compares the E_Z[2:0] field of the incoming cell with its Z ID. If the Z values match, the cell is processed, otherwise the cell is dropped.

When a service card fails, the associated egress traffic is switched to a protection card. In order to accomplish the switching, the AGR uses a 3-bit wide, eight entry deep Z-mapping table with each entry associated with one of the eight AIF ports. Each entry in the Z-mapping table contains the current mapped/unmapped Z address of the corresponding AIF port. The egress transmit logic in the AGR receives a cell from the egress receive logic, it looks up the Z mapping table used to overwrite the E_Z field of the outgoing egress cell. During normal operation, each entry in this table contains the Z address of the ARB connected to the associated AIF port. When one of the service cards fails, the Z address of the failed card and the protection card are swapped by the associated software. The Z address of the failed service card is now mapped to the Z address of the protection card and vice versa. Consequently, the egress traffic destined for the failed service card will now be accepted by the protection card.

It is desirable to have the Z-mapping table lookup disabled for test cells. For example, when a service card is being protected, it must still be able to receive test cells destined to it. Thus, test cells destined for the failed service card must not be mapped whereas user data cells destined for the same card must be mapped. The IGNR_Z bit in the egress cell header is therefore provided to override the Z-mapping lookup table. Hence, the Z-mapping table lookup will only be performed when the IGNR_Z bit is set to 0.

The foregoing description merely illustrates the principles of the invention. It will thus be appreciated that those skilled in the art will be able to devise various arrangements, which, although not explicitly described or shown herein, embody the principles of the invention, and are included within its spirit and scope. Furthermore, all examples and conditional language recited are principally intended expressly to be only for instructive purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Many other modifications and applications of the principles of the invention will be apparent to those skilled in the art and are contemplated by the teachings herein. Accordingly, the scope of the invention is limited only by the claims appended hereto.

What is claimed is:

1. A telecommunications apparatus comprising:
a plurality of telecommunications physical layer interfaces,
one or more telecommunications higher-layer processors, and
a digital cross-connect connected to route telecommunications traffic among the physical layer interfaces and the one or more higher-layer processors.

2. The apparatus of claim 1 wherein at least one of the physical layer interfaces is a SONET physical layer interface.

3. Th apparatus of claim 1 wherein a higher layer processor is an asynchronous transfer mode (ATM) processor.

4. The apparatus of claim 1 wherein a higher layer processor is an internet protocol (IP) processor.

5. The apparatus of claim 2 wherein the digital cross-connect is configured to provide 1:1 automatic protection switching for communications traffic from at least one of the physical layer interfaces to one or more higher-layer interfaces.

6. The apparatus of claim 2 wherein the digital cross-connect is configured to provide 1:N automatic protection switching for communications traffic from at least one of the physical layer interfaces to one or more higher-layer interfaces.

7. The apparatus of claim 2 wherein the digital cross-connect is configured to provide 1:1 automatic protection switching for communications traffic to at least one of the physical layer interfaces from one or more higher-layer interfaces.

8. The apparatus of claim 2 wherein the digital cross-connect is configured to provide N:1 automatic protection switching for communications traffic to at least one of the physical layer interfaces from one or more higher-layer interfaces.

9. A packet-switching system comprising:
one or more telecommunications apparatuses, each apparatus including:
a plurality of telecommunications physical layer interfaces,
one or more telecommunications higher-layer processors, and
a digital cross-connect connected to route telecommunications traffic among the physical layer interfaces and the one or more higher-layer processors, and
a packet switch fabric connected to switch telecommunications traffic received at one or more of the physical layer interfaces to one or more of the physical layer interfaces.

10. The system of claim 9 wherein at least one of the physical layer interfaces is a SONET physical layer interface.

11. The system of claim 9 wherein a higher layer processor is an asynchronous transfer mode (ATM) processor.

12. The system of claim 9 wherein a higher layer processor is an internet protocol (IP) processor.

13. The system of claim 10 wherein the digital cross-connect is configured to provide 1:1 automatic protection switching for communications traffic from at least one of the physical layer interfaces to one or more higher-layer interfaces.

14. The system of claim 10 wherein the digital cross-connect is configured to provide 1:N automatic protection switching for communications traffic from at least one of the physical layer interfaces to one or more higher-layer interfaces.

15. The system of claim 10 wherein the digital cross-connect is configured to provide 1:1 automatic protection switching for communications traffic to at least one of the physical layer interfaces from one or more higher-layer interfaces.

16. The system of claim 10 wherein the digital cross-connect is configured to provide N:1 automatic protection switching for communications traffic to at least one of the physical layer interfaces from one or more higher-layer interfaces.

17. A method of switching telecommunications traffic comprising the steps of:
(A) receiving telecommunications traffic at a telecommunications physical interface;
(B) routing the received telecommunications traffic from the physical interface to a digital cross-connect; and
(C) routing the telecommunications traffic through the cross-connect to a telecommunications higher-layer processor.

18. The method of claim 17 further comprising the step of:
(D) routing the telecommunications from the higher-layer processor through a packet switch fabric to a higher-layer processor;
(E) routing the telecommunications from the higher layer processor to a digital cross-connect; and
(F) routing the telecommunications from the higher layer processor to a telecommunications physical interface.

19. The method of claim 17 wherein the step (A) of receiving telecommunications traffic further comprises the step of:
(A1) receiving telecommunications at a SONET physical layer interface.

20. The method of claim 17 wherein the step (C) of routing the telecommunications traffic further comprises the step of:
(C1) routing the telecommunications traffic to an asynchronous transfer mode (ATM) processor.

21. The method of claim 17 wherein the step (C) of routing the telecommunications traffic further comprises the step of:
(C2) routing the telecommunications traffic to an internet protocol (IP) processor.

22. The method of claim 17 wherein the step (C) of routing the telecommunications traffic further comprises the step of:
(C3) providing 1:1 automatic protection switching for communications traffic from at least one of the physical layer interfaces to one or more higher-layer interfaces.

23. The method of claim 17 wherein the step (C) of routing the telecommunications traffic further comprises the step of:
(C4) providing 1:N automatic protection switching for communications traffic from at least one of the physical layer interfaces to one or more higher-layer interfaces.

24. The method of claim 18 wherein the step (E) of routing the telecommunications traffic further comprises the step of:
(E1) providing 1:1 automatic protection switching for communications traffic to at least one of the physical layer interfaces from one or more higher-layer interfaces.

25. The method of claim 18 wherein the step (E) of routing the telecommunications traffic further comprises the step of:
(E2) providing N:1 automatic protection switching for communications traffic to at least one of the physical layer interfaces from one or more higher-layer interfaces..
